(19) United States
(12) Patent Application Publication
(10) Pub. No.: US 2012/0019353 A1
(43) Pub. Date: Jan. 26, 2012

(54) Systems and Methods for Automatically Activating Monitoring Systems

(75) Inventor: Donald Lee Knasel, Longmont, CO (US)

(73) Assignee: MYSNAPCAM, LLC, Atlanta, GA (US)

(21) Appl. No.: 13/191,098

(22) Filed: Jul. 26, 2011

Related U.S. Application Data
(60) Provisional application No. 61/367,674, filed on Jul. 26, 2010.

(51) Int. Cl. G05B 19/02

(52) U.S. Cl. 340/4.35; 340/4.3

(57) ABSTRACT

Systems and methods for activating monitoring systems are provided. One or more parameters associated with the automatic activation of a monitoring system may be identified. The one or more parameters may be identified by a learning algorithm based upon historical information associated with the monitoring system. A determination may be made as to whether the one or more parameters have been satisfied. If it is determined that the one or more parameters have been satisfied, the monitoring system may be automatically activated. In certain embodiments, the above operations may be performed by a system that includes one or more computers.

### CROSS-REFERENCE TO RELATED APPLICATIONS

This application claims benefit of U.S. Provisional Application No. 61/367,674 filed Jul. 26, 2010 and entitled “Method for Activating and De-Activating a Monitoring System,” the disclosure of which is incorporated by reference herein in its entirety.

### FIELD OF THE INVENTION

Embodiments of the invention relate generally to monitoring systems, such as security systems, and more specifically to the automatic activation and/or deactivation of monitoring systems.

### BACKGROUND OF THE INVENTION

Monitoring systems used in homes, businesses, and/or other structures, such as security monitoring systems, must often be manually activated in order to detect desired activities, such as security breeches. However, in conventional monitoring systems, activation can be an inconvenience or proper activation may not be performed. For example, an individual may forget to activate a monitoring system when leaving for work. Additionally, due to the rarity of security breeches and other detectable events, a user may tend to become complacent. Because monitoring systems are often not activated, the occurrence of detecting desired activities may be rare. In fact, in many communities, most burglaries and break-ins occur between 10 AM and 2 PM when the homeowner has stepped out of the home. Accordingly, there is an opportunity for improved systems and methods for activating and deactivating a monitoring system.

### BRIEF DESCRIPTION OF THE INVENTION

Some or all of the above needs and/or problems may be addressed by certain embodiments of the invention. Embodiments of the invention may include systems and methods for activating and de-activating monitoring systems. According to one embodiment of the invention, there is disclosed a method for automatically activating a monitoring system. One or more parameters associated with the automatic activation of a monitoring system may be identified. The one or more parameters may be identified by a learning algorithm based upon historical information associated with the monitoring system. A determination may be made as to whether the one or more parameters have been satisfied. If it is determined that the one or more parameters have been satisfied, the monitoring system may be automatically activated. In certain embodiments, the above operations may be performed by a system that includes one or more computers.

According to another embodiment of the invention, there is disclosed a system for automatically activating a monitoring system. The system may include at least one memory and at least one processor. The at least one memory may be configured to store computer-executable instructions. The at least one processor may be configured to access the at least one memory and execute the computer-executable instructions to: identify one or more parameters associated with the automatic activation of a monitoring system, wherein the one or more parameters are identified by a learning algorithm based upon historical information associated with the monitoring system; determine that the one or more parameters have been satisfied; and automatically activate the monitoring system based upon the determination that the one or more parameters have been satisfied.

Additional systems, methods, apparatus, features, and aspects are realized through the techniques of various embodiments of the invention. Other embodiments and aspects of the invention are described in detail herein and are considered a part of the claimed invention. Other embodiments and aspects can be understood with reference to the description and the drawings.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of one example system that may be utilized to automatically activate and/or deactivate a monitoring system, according to an illustrative embodiment of the invention.

FIG. 2 is a flow diagram of an example method for automatically activating a monitoring system, according to an illustrative embodiment of the invention.

FIG. 3 is a flow diagram of an example method for detecting and processing events by an activated monitoring system, according to an illustrative embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are systems and methods for automatically activating and/or deactivating monitoring systems. In one example embodiment, one or more activation parameters may be utilized in conjunction with collected monitoring data in order to determine whether to automatically activate a monitoring system. For example, one or more user parameters or preferences and/or default parameters may be identified by a system that determines whether to automatically activate a monitoring system. The one or more parameters may then be evaluated in conjunction with monitoring data and/or other data in order to determine whether the monitoring system will be automatically activated. In this regard, additional security may be provided for a monitored structure.

A wide variety of different types of parameters may be evaluated as desired in various embodiments of the invention. Examples of suitable parameters that may be evaluated include, but are not limited to, timing thresholds, threshold activity levels, thresholds associated with different types of sensors, parameters associated with an order in which sensors are activated, and/or parameters associated with user devices in communication with a monitoring system. For example, a monitoring system may be automatically activated in the event that no motion or movement is detected for a predetermined period of time (e.g., 15 minutes, 30 minutes, etc.). In this regard, if a user leaves the household, the monitoring system may be automatically activated at a later point in time. As another example, a monitoring system may be automatically activated in the event that one or more user devices, such as a mobile device (e.g., a mobile phone, etc.), ceases to communicate with the monitoring system. As long as at least one relevant user device is in range of the monitoring system, the system may be maintained in an unarmed state (or a armed “home” state); however, when the users leave and the monitoring system can no longer detect the user device(s), the monitoring system may be automatically activated.

As desired, different parameters may be utilized for different times of the day and/or days of the week. For example, a determination of whether to automatically activate a monitoring system at a time when a user is typically at work may be different than a determination of whether to automatically activate a monitoring system at a time when the user is typically at home. Different parameters and/or thresholds may be utilized for the different times. For example, if the current date and time indicates that a user is likely at work or otherwise out of the home, then the monitoring system may be automatically activated if certain parameters are met (e.g., no activity, no contact with a user device, etc.). As another example, if the current date and time indicates that a user is likely at home, then different parameters may be evaluated in determining whether to automatically activate the monitoring system. Additionally, the monitoring system may be activated in an “at home” or “stay” mode rather than an “away” mode if the date and time indicates that the user is likely at home.

As desired, one or more parameters may also be evaluated in order to determine whether the monitoring system will be automatically deactivated. For example, if a user device reestablishes communication with the monitoring system, the monitoring system may be automatically deactivated. As another example, if a user device reestablishes communication with the monitoring system in conjunction with the monitoring system detecting motion or other activity, then the monitoring system may be automatically deactivated. As another example, if a user typically sleeps upstairs, then downstairs motion detectors may be activated at night. The downstairs motion detectors may then be automatically deactivated if motion is first detected upstairs and/or in a stairwell.

In certain embodiments of invention, at least one learning algorithm and/or components of one or more learning algorithms algorithm(s) may be utilized. For example, a learning algorithm may be implemented on a central server in communication with a local monitoring system. Additionally or alternatively, a learning algorithm or components of the algorithm may be implemented on the components of the local monitoring system. As desired, a user may seed an algorithm with starting information to improve its initial accuracy. For example, one or more user profiles and/or initial user preferences may be provided to an algorithm. Alternatively, in other embodiments, an algorithm may be allowed to “learn” or determine a relatively optimal rule set over time without initial input.

In operation, the learning algorithm may receive data collected by the monitoring system, such as monitoring data (e.g., sensor data, user device data, identified events data, etc.). In this regard, historical monitoring data may be collected. The learning algorithm may then process at least a portion of the collected data, and the learning algorithm may dynamically or periodically adjust one or more parameters that are evaluated in activation and/or deactivation determination. For example, the learning algorithm may utilize historical data to generate a profile associated with expected monitoring activity. The profile may then be evaluated in order to identify one or more activation parameters and/or to determine whether the monitoring system will be activated and/or deactivated.

As desired, the algorithm may manage the activation/deactivation of the monitoring system based upon the detection of a wide variety of inputs (and/or lack of inputs) that may be collected by the monitoring system. As desired, inputs may be received from any number of devices and/or utilizing any number of techniques. For example, input may be received utilizing one or more of electronic sensors, motion detectors, microphones that detect audio information, cameras that detect video information, sensors that detect the interaction of other user devices (e.g., mobile devices, etc.) with the system, etc.

Various embodiments of the invention may include one or more special purpose computers, systems, and/or particular machines that facilitate the automatic activation and/or deactivation of a monitoring system. A special purpose computer or particular machine may include a wide variety of different software modules as desired in various embodiments. As explained in greater detail below, in certain embodiments, these various software components may be utilized to establish and/or dynamically adjust a profile and/or one or more parameters that are evaluated in order to activate and/or deactivate a monitoring system. The various software components may also be utilized to evaluate monitoring information in association with the parameters in order to determine whether the monitoring system will be automatically activated or deactivated.

Structural Overview

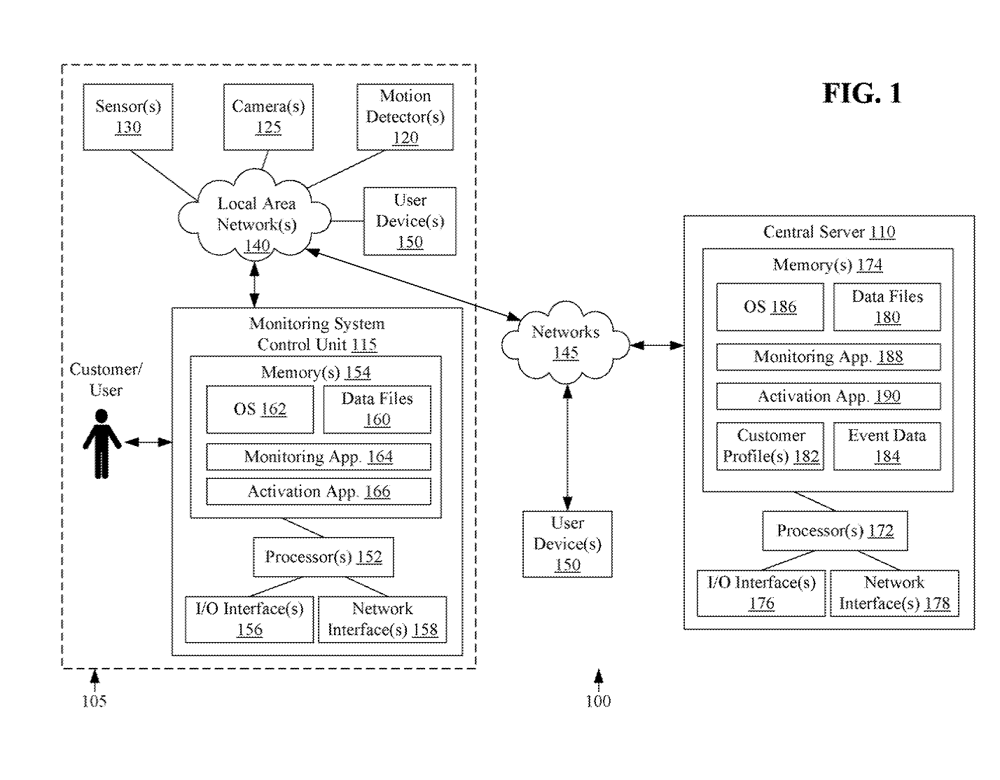

FIG. 1 illustrates one example system 100 that facilitates the automatic activation and/or deactivation of a monitoring system. With reference to FIG. 1, the system 100 may include a wide variety of components that are situated within or within relatively close proximity to a structure that is monitored, such as a home or business. For example, various monitoring components may be situated within a household 105. Additionally, in certain embodiments, the system 100 may include a central server 110 configured to receive data, such as sensor data and/or monitoring data from the household 105 and/or the various components associated with the household 105.

For purposes of this disclosure, the entire system 100 may be referred to as a “monitoring system” with the components associated with the household 105 being referred to as a “local monitoring system.” However, for simplicity, the components associated with the household 105 may be referred to as a monitoring system rather than a local monitoring system. Such language should not be construed as limiting the meaning of the term “monitoring system” to local components associated with a household 105.

With reference to the household 105, a local monitoring system control unit 115 and/or any number of sensing devices, such as motion detectors 120, cameras 125, and/or other sensors 130 (e.g., microphones or voice detectors, smoke detectors, contact sensors, etc.) may be provided. As desired, the control unit 115 may communicate with the sensors via any number of suitable local networks 140 or household networks, such as a local area network, a home area network (“HAN”), a Bluetooth-enabled network, a Wi-Fi network, a wireless network, a suitable wired network, etc. As desired, the control unit 115 may additionally communicate with any number of user devices 150 via the local networks 140, such as a mobile device or other device associated with a user.

Additionally, the control unit 115 and/or any number of the sensors 120, 125, 130 may communicate with any number of external devices, such as the central server 110, via any number of suitable external networks 145, such as a cellular network, a public-switched telephone network, an Advanced Metering Infrastructure (“AMI”) network, the Internet, and/or any other suitable public or private network. As desired, the user devices 150 may also communicate with the central server 110 and/or the monitoring system control unit 115 via the external networks 145.

In certain embodiments, the control unit 115 may be a standalone device, such as a monitoring system panel that includes suitable hardware and/or software components. In other embodiments, the control unit 115 may be integrated into one or more of the other illustrated system components 120, 125, 130. In yet other embodiments, the control unit 115 may be integrated into a wide variety of other devices not illustrated in FIG. 1, such as a utility meter or a home power management system. As desired, the functionality of the control unit 115 may also be distributed among a plurality of different devices.

The control unit 115 may be a suitable processor-driven device that facilitates the management of a monitoring system, such as a household monitoring system. Additionally, in certain embodiments, the control unit 115 may be a suitable processor-driven device that facilitates the evaluation of parameters and/or monitoring data in order to determine whether the monitoring system and/or various sensors will be automatically activated and/or deactivated. Examples of suitable devices that may be utilized for and/or associated with the control unit 115 include, but are not limited to, personal computers, microcontrollers, minicomputers, and/or other suitable processor-driven devices. The one or more processors 152 associated with the control unit 115 may be configured to execute computer-readable instructions in order to form a special purpose computer or particular machine that is configured to manage a local monitoring system and/or to facilitate the automatic activation and/or deactivation of the local monitoring system.

In addition to having one or more processors 152, the control unit 115 may include one or more memory devices 154, one or more input/output (“I/O”) interfaces, and/or one or more network interfaces. The memory devices 154 may include any suitable memory devices and/or data storage elements, such as read-only memory devices, random access memory devices, magnetic storage devices, etc. The memory devices 154 may be configured to store a wide variety of information, for example, data files 160, user profile data, and/or any number of software modules and/or executable instructions that may be executed by the one or more processors 154, such as an operating system (“OS”) 162, a monitoring application 164 and/or an activation application 166.

The data files 160 may include any suitable data that facilitates the operation of the control unit 115, such as data that facilitates identification of the one or more sensors 120, 125, 130, data that facilitates communication with the sensors 120, 125, 130, data that facilitates identification of and/or communication of the user devices 150, data that facilitates communication with the central server 110, collected monitoring data, user profile data, and/or various parameters and/or preferences associated with the automatic activation and/or deactivation of the monitoring system. The OS 162 may be a suitable software module that facilitates the general operation of the control unit 115. Additionally, the OS 162 may facilitate the execution of any number of other software modules, such as the monitoring application 164 and/or the activation application 166.

In operation, the control unit 115 may facilitate the management of a local monitoring system, such as a household monitoring system. For example, the control unit 115 may communicate with one or more sensors 120, 125, 130 and/or user devices 150 in order to collect monitoring data and/or to determine when an alarm event or other event should be triggered. Additionally, in certain embodiments, the control unit 110 may determine whether the monitoring system should be activated and/or deactivated. In other embodiments, the central server 110 may determine whether the monitoring system should be activated and/or deactivated. For example, an activation application 166 associated with the control unit 110 and/or an activation application 190 associated the central server 110 may determine whether the monitoring system should be activated and/or deactivated.

As desired, a monitoring application 164 associated with the control unit 110 and/or a central server 110 in communication with the control unit 110 may facilitate the collection of monitoring data, the identification of alarm events, and/or the execution of one or more control actions based upon triggered alarm events. The monitoring application 164 may be a suitable software module that receives the various inputs from sensors 120, 125, 130, user devices 150, etc. and executes one or more action(s) based at least in part upon a rule database and/or an artificial intelligence application. For example, the monitoring application 164 may identify alarm events and trigger an alarm and/or other control actions (e.g., escalation of an alarm, contacting a customer, etc.) in association with the identification of an alarm event.

The activation application 166 may be a suitable software module that controls the activation and/or deactivation of the monitoring system. For example, the activation application 166 may be configured to identify any number of conditions associated with the activation of a monitoring system and/or the activation application 166 may activate the monitoring system based upon the identified conditions. Additionally, as desired, the activation application 166 may be configured to determine when the monitoring system and/or various sensors should be deactivated subsequent to the identification of a wide variety of different events, such as a triggering event. As desired, the activation application 166 may include one or more learning algorithms configured to utilize collected data to dynamically modify and/or adapt a user profile and/or various conditions and/or parameters that are evaluated in activation and deactivation determination. Additionally, in order to facilitate the activation and/or deactivation of the monitoring system, the activation application 166 may be configured to switch and/or direct the switching of any number of sensor devices to another state (e.g., an on state, a standby state, and/or an off state) and/or instruct any number of other applications running on the system to change state.

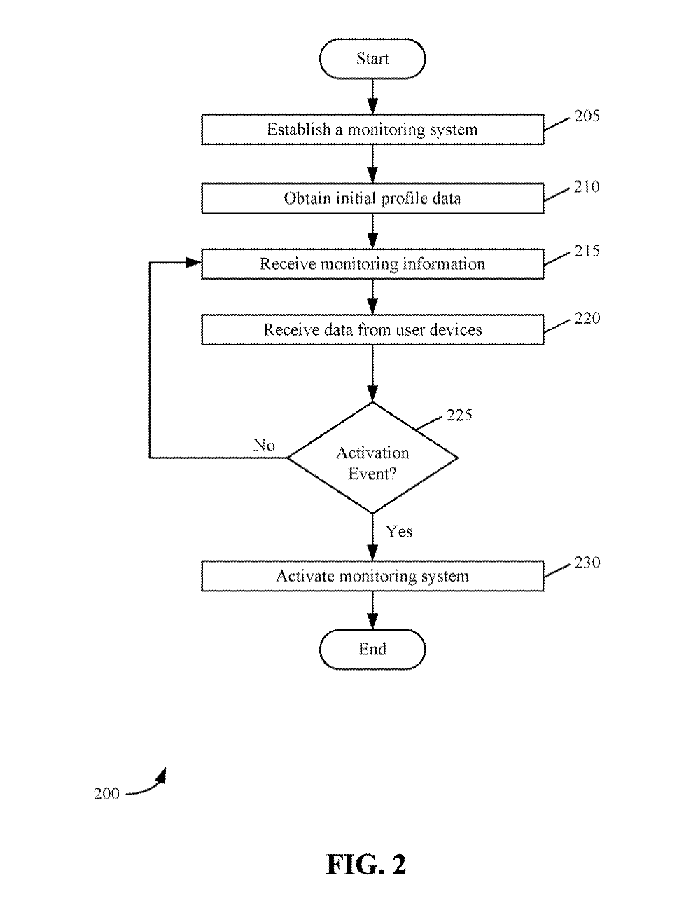

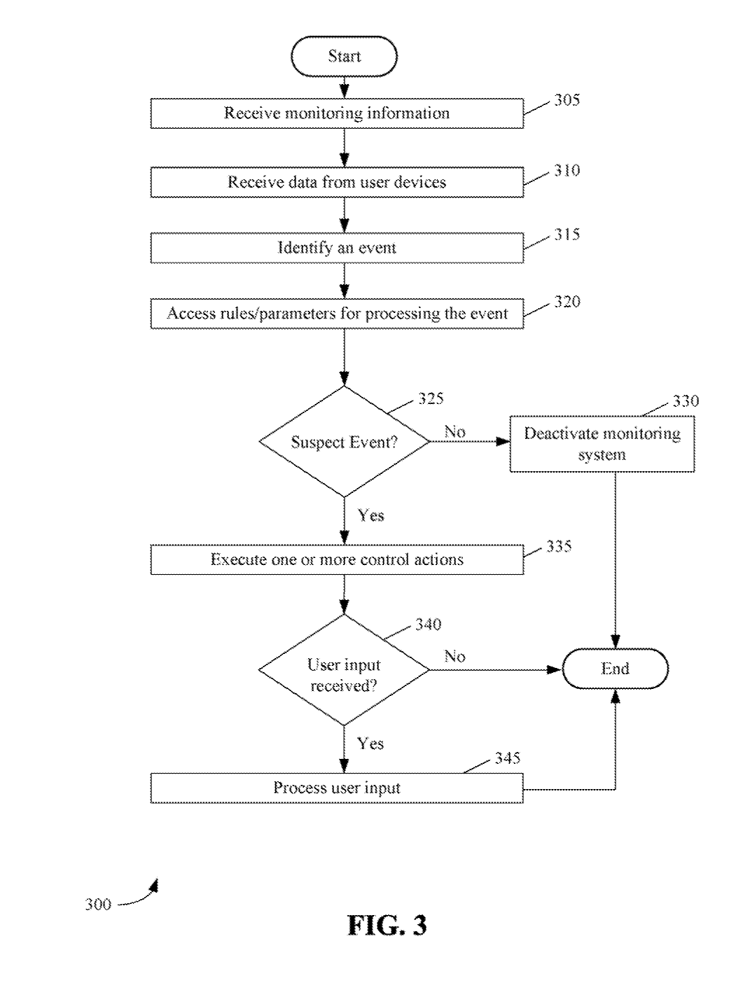

One example of the operations that may be performed by the activation 166 is described in greater detail below with reference to FIGS. 2 and 3.

With continued reference to the control unit 115, one or more input/output (“I/O”) interfaces 156 may facilitate interaction with any number of I/O devices that facilitate the receipt of user and/or device input by the control unit 115, such as a keyboard, a touch screen display, a microphone, etc. Additionally, the one or more network interfaces 158 may facilitate connection of the control unit 115 to any number of suitable networks, such as the local area networks 140 and/or the external networks 145. In this regard, the control unit 115 may communicate with any number of other components of the system 100. For example, the control unit 115 may receive data from sensors 120, 125, 130 and/or user devices 150. As another example, the control unit 115 may communicate commands to the various sensors 120, 125, 130. As yet another example, the control unit 115 may communicate data to and/or receive data from the central server 110.

With continued reference to FIG. 1, the central server 110 may be a suitable processor-driven device configured to receive data from any number of local control units 115 and/or to determine whether one or more monitoring system should be activated and/or deactivated. For example, the central server 110 may include any number of suitable server computers, personal computers, minicomputers, microcontrollers, and/or other processor-based devices. In certain embodiments, the central server 110 may execute computer-executable instructions that form a special purpose computer or particular machine that facilitates the determination of whether an associated monitoring system, such as a customer monitoring system or local monitoring system, should be activated and/or deactivated. Although the central server 110 is described in greater detail below as determining when the monitoring system should be activated/de-activated, as desired, at least a portion of the operations of the central server 110 described below and/or at least a portion of the operations described with reference to FIGS. 2 and 3 may be performed by the monitoring system control unit 115.

In addition to having one or more processors 172, the central server 110 may include any one or more suitable memory devices 174, one or more suitable input/output (“I/O”) interfaces 176, and/or one or more suitable network interfaces 178. The memory devices 174 may include any suitable memory devices, such as read-only memory devices, random access memory devices, magnetic storage devices, etc. The memory devices 174 may be configured to store a wide variety of data utilized by the central server 110, for example, data files 180, one or more customer profile databases 182, one or more event data databases 184, and/or any number of databases and/or other logical memory constructs. Additionally, the memory devices 174 may be configured to store various software modules and/or executable instructions that may be executed by the one or more processors 172, such as a monitoring application 188 and/or an activation application 190.

The data tiles 180 may include any suitable data that facilitates the general operation of the central server 110 and/or the monitoring system, as well as determinations of whether the monitoring system should be activated and/or deactivated. For example, the data files 180 may include various settings information associated with any number of household monitoring systems, contact information and/or network data associated with the household monitoring systems, and/or contact information associated with the user devices 150. The customer profile databases 182 may include, for example, various application rules, preferences, parameters, and/or user profiles associated with one or more customers, such as customer profile information that is utilized to determine whether a monitoring system should be activated and/or deactivated. In certain embodiments of the invention, a customer profile may be initially populated with data received from the customer and/or with default values. The customer profile may then be modified and/or altered over time by a suitable learning algorithm. The event data databases 184 may include, for example, recent sensor activity and/or triggered event data that is received from the monitoring system control unit 115 and/or any number of sensors 120, 125, 130. A wide variety of different files and/or logical memory constructs may be utilized to store data utilized in various embodiments of the invention. The various files and databases described above are provided by way of example only and should not be construed as limiting.

The operating system (“OS”) 186 may be a suitable software module that facilitates the general operation of the central server 110. Additionally, the OS 186 may facilitate the execution of any number of other software modules, such as the monitoring application 188 and/or the activation application 190. The monitoring application 188 may be a suitable software module that receives various inputs from sensors: user devices, etc. and executes one or more action(s) based on rules stored in the customer profiles 182. For example, the monitoring application 188 may identify alarm events and trigger an alarm and/or other control actions (e.g., escalation of an alarm, contacting a customer, etc.) in association with the identification of an alarm event. As desired, the monitoring application 188 may include a wide variety of artificial intelligence and/or learning algorithms that dynamically or periodically alter the customer profiles 182 based upon an analysis of historical monitoring data. In this regard, the various parameters that are evaluated to identify an alert or alarm event may be dynamically adjusted over time.

The activation application 190 may be a suitable software module that controls the activation and/or deactivation of a monitoring system. For example, the activation application 190 may be configured to identify any number of conditions and/or parameters associated with the automatic activation of a monitoring system, and the activation application 190 may be configured to direct the automatic activation of the monitoring system based at least in part upon a determination that the identified conditions or parameters have been satisfied. Additionally, in certain embodiments, the activation application 190 may be configured to determine when the monitoring system and/or various sensors 120, 125, 130 associated with the monitoring system should be deactivated subsequent to the identification of an alarm or triggering event. As desired, in order to facilitate the activation and/or deactivation of the monitoring system, the activation application 190 may be configured to switch any number of sensor devices to another state (e.g., an on state, a standby state, and/or an off state) and/or to instruct any number of other applications running on the system to change state.

One example of the operations that may be performed by the activation application 190 is described in greater detail below with reference to FIGS. 2 and 3.

With continued reference to the central server 110, one or more input/output (“I/O”) interfaces 176 may facilitate interaction with any number of I/O devices that facilitate the receipt of user and/or device input by the central server 110, such as a keyboard, a mouse, a touch screen display, a microphone, etc. Additionally, the one or more network interfaces 178 may facilitate connection of the central server 110 to any number of suitable networks, such as a cellular network, a public-switched telephone network, the Internet, etc., that facilitate communications between the central server 110 and one or more other components of the system 100, such as the monitoring system control unit 115 and/or any number of user devices 150, such as a mobile device of a user. In this regard, the central server 110 may receive monitoring and/or measurements data from the control unit 115. Additionally, as desired, the central server 110 may receive user commands and/or requests for data from the control unit 115 and/or the user devices 150.

With continued reference to FIG. 1, any number of user devices 150 may be provided. One example of a suitable user device 150 is a mobile device (e.g., a mobile telephone, a personal digital assistant, etc.), although other types of user devices may be utilized, such as tablet computers, digital readers, etc. In certain embodiments, the user devices 150 may be recognized by and/or in communication with the control unit 115, any number of sensors associated with a household monitoring system, and/or the central server 110. As desired, location information and/or recognition information associated with a user device 150 may be utilized in a determination of whether a monitoring system should be activated and/or deactivated. For example, if location information (e.g., GPS information) associated with a user's mobile device indicates that the device has traveled a threshold distance away from the household, then a decision may be made to activate the monitoring system. As another example, if a user's mobile device is identified by and/or in communication with the control unit 115 via the local network 140, then a determination may be made that the monitoring system should be deactivated.

Additionally, as desired, a user may utilize a user device 150 to provide commands to and/or receive data from one or more other components of the system 100. For example, a user device 150 may be configured to receive alarm data and/or event data from the control unit 115 and/or the central server 110, and at least a portion of the received data may be presented to a user. As another example, a user may utilize a user device 150 to provide any number of commands associated with the monitoring system to the control unit 115 and/or the central server 110, such as an activation command, a deactivation command, a command to escalate an alarm, etc.

As desired, embodiments of the invention may include a system 100 with more or less than the components illustrated in FIG. 1. The system 100 of FIG. 1 is provided by way of example only.

Operational Overview

FIG. 2 illustrates a flow diagram of one example method 200 for automatically activating a monitoring system. Various operations of the method 200 may be performed by a monitoring system control unit and/or by a central server, such as the control unit 115 and/or central server 110 illustrated in FIG. 1. For example, various operations of the method 200 may be performed by a suitable activation application associated with the control unit 115 and/or by a suitable activation application associated with the central server 110, such as one or both of the activation applications 166, 190 illustrated in FIG. 1. The method may begin at block 205.

At block 205, a monitoring system may be established. For example, a monitoring system may be installed at a household or other structure. The established monitoring system may include any number of components, such as a wide variety of different sensors (e.g., motion detectors, cameras, sound detectors, contact sensors, smoke alarms, etc.) and/or any number of suitable control units. In certain embodiments, a local control unit may be in communication with a central server or a central monitoring system. Additionally, in certain embodiments of the invention, at least one of a local control unit and/or a central server may be configured to execute one or more suitable learning algorithms utilized in association with activation and/or deactivation determinations.

At block 210, initial user profile data associated with the monitoring system may be obtained and/or identified. For example, one or more user-specified parameters and/or default parameters may be identified. The one or more parameters may include a wide variety of different parameters associated with, for example, the control of one or more sensors, communication with one or more user devices, the automatic activation of the monitoring system, the automatic deactivation of the monitoring system, the identification of alert events and/or suspicious events, and/or the processing of identified alert events. A wide variety of different information may be received as desired in various embodiments of the invention.

Example user preferences associated with conditions for automatically activating the monitoring system include, but are not limited to, one or more time thresholds utilized to activate the monitoring system if no event data or sensor data is collected within the time threshold period, activation parameters associated with the interaction of user devices with the system (e.g., communication parameters, geographical distance parameters, etc.), and/or time of day and/or day of week parameters in which the monitoring system should be activated. Examples of user preferences associated with conditions for automatically deactivating the monitoring system include, but are not limited to, timing parameters and/or user device interaction parameters that result in an automatic deactivation of the monitoring system and/or parameters associated with a particular sequence of detected activity that results in automatic deactivation of the monitoring system. Examples of user preferences associated with the processing of identified alarm conditions and/or suspicious events include, but are not limited to, parameters that define a period of time that various sensors should be activated to record event data following a detection of an alarm event, parameters for contacting a user based upon a detected event, and/or parameters associated with the escalation of an alert event.

In certain embodiments, the initial profile data may be provided to a learning algorithm that dynamically and/or periodically adjusts the parameters. For example, the initial profile data may be used to seed a learning algorithm. Alternatively, default of generate profile data may be utilized. Additionally, a wide variety of suitable methods may be utilized to obtain profile data and/or preferences from a user. For example, one or more user interface screens provided by a suitable controller and/or an associated Web server may be utilized to receive user options.

At block 215, a wide variety of monitoring information may be received and/or collected by the monitoring system. For example, data (e.g., motion detector data, audio data, etc.) may be received from any of the sensors associated with the monitoring system. Additionally, at block 220, data may be received from one or more user devices in communication with the monitoring system. For example, device identification information and/dr device location information (e.g., global positioning system coordinates, etc.) may be received from a user device. Additionally, based upon stored information associated with the user devices, a determination may be made as to whether any local area connections (e.g., a Wi-Fi connection, a Bluetooth connection, etc.) may be established between a local monitoring device and one or more user devices.

At block 225, a determination may be made as to whether at least one automatic activation event is identified. An automatic activation event may define one or more conditions or parameters that result in the automatic activation of a monitoring system or the change of state of the monitoring system (or various sensors associated with the monitoring system) to an armed or active monitoring state. A wide variety of different types of activation events may be identified as desired in various embodiments of the invention. For example, a user profile associated with the monitoring system may include a wide variety of parameters associated with different types of activation events.

As one example activation event, one or more parameters may specify that a monitoring system will be automatically activated in the event that a user device has been determined to no longer be in communication with a sensor and/or when a user device has been determined to be a sufficient distance away from a household (i.e., a distance determined based upon GPS coordinates associated with the user device). Each of these user device events may be coupled with a determination that no movement or other activity is detected, that no movement or other activity has been detected for a predetermined period of time, and/or a determination that the time of day and/or day of week are associated with historical periods of time in which the monitoring system has been activated. Another example of an activation event is a determination that no movement, motion, sound, and/or other activity has been detected for a predetermined threshold period of time. Similar to the user device event described above, a lack of activity event may be combined with time of day and/or day of week parameters.

In certain monitoring systems, different activation levels may be utilized. For example, a monitoring system may be activity in either a “stay” (or “at home”) mode or an “away” mode. As desired, different activation events may be associated with automatically activating different modes of a monitoring system. For example, if it is determined that a user device is in communication with the monitoring system (or within the home) and that no motion activity is detected, then it may be assumed that the user is likely at home (e.g., asleep, etc.) and the monitoring system may be activated in a “stay” mode. Additionally, in certain embodiments, certain sensors may be selectively activated based upon detected activation events. For example, if activity is detected in a first area of a household, such as the upstairs, then motion detectors may be armed in a second area of the household, such as downstairs. Subsequently, if detected motion indicates that the user is moving from the first area to the second area (e.g., moving to and/or going down the stairs, etc.), then the armed motion detectors in the second area may be deactivated.

Additionally, in accordance with an aspect of the invention, collected monitoring data (e.g., sensor data, user device data, etc.) and/or event data (e.g., triggered alerts, user overrides of alerts, etc.) may be provided to a suitable learning algorithm. For example, data may be provided to a suitable a rules based algorithm that includes any number of learning functions, feedback evaluation functions, and/or artificial intelligence functions that facilitate adaptation of the algorithm over time. In this regard, the learning algorithm may store historical data associated with monitoring performed by the monitoring system. As desired, the learning algorithm may also generate one or more prompts to receive user input associated with evaluated data and/or detected events. The learning algorithm may then evaluate at least a portion of the stored data and/or user input, and the user profiles and/or activation/deactivation parameters may be updated or modified based at least in part upon the evaluation. For example, historical activity detection data may be utilized to determine time periods (e.g., hours of the day, days of the week, etc.) in which one or more users are likely present within a home or away from the home. This data may then be utilized in conjunction with subsequent automatic activation and/or deactivation determinations. As another example, a determination may be made that a user typically overrides an automatic activation within a certain period of time (e.g., 20 minutes, etc.) during certain time periods and/or days. For example, a user may typically go out for a quick jog or walk during weekday mornings. In such a situation, a determination may be made by the learning algorithm to either not automatically activate the monitoring system during such periods or to automatically deactivate the monitoring system upon certain events (e.g., the user entering through a certain door within a certain time period of activation, etc.).

If it is determined at block 225 that an activation event has not been identified, then operations may continue at block 215, and the receipt and/or processing of monitoring data and/or user device data may be continued. If, however, it is determined at block 225 that an activation event has been identified, then operations may continue at block 230. At block 230, the monitoring system may be automatically activated. As desired, a type of activation (e.g., “stay” mode, “away” mode, desired sensors to be activated, etc.) may be determined based at least in part upon one or more parameters associated with the identified activation event. In other words, different types of activation events may result in varying activation levels.

The method 200 may end following block 230.

FIG. 3 illustrates a flow diagram of one example method 300 for identifying and processing events by an activated monitoring system. Various operations of the method 300 may be performed by a monitoring system control unit and/or by a central server, such as the control unit 115 and/or central server 110 illustrated in FIG. 1. For example, various operations of the method 300 may be performed by one or more suitable monitoring and/or activation applications associated with the control unit 115 and/or the central server 110. The method may begin at block 305.

At block 305, a wide variety of monitoring information may be received and/or collected by the monitoring system. For example, data (e.g., motion detector data, audio data, etc.) may be received from any of the sensors associated with the monitoring system. Additionally, at block 310, data may be received from one or more user devices in communication with the monitoring system. For example, device identification information and/or device location information (e.g., global positioning system coordinates, etc.) may be received from a user device. Additionally, based upon stored information associated with the user devices, a determination may be made as to whether any local area connections (e.g., a Wi-Fi connection, a Bluetooth connection, etc.) may be established between a local monitoring device and one or more user devices.

At block 315, at least one event may be identified based at least in part upon the monitoring information and/or the user device information. A wide variety of different types of events may be identified as desired in various embodiments of the invention, such as alert events, motion events, device communication events, etc. For example, a determination may be made that a sensor on or off state, changes to video or sound, user device status or location, etc. has exceeded a decision threshold. Additionally, the identified events may be processed utilizing a wide variety of different methods and/or techniques. At block 320, various rules and/or parameters (e.g., timing rules, device communication rules, time of day rules, day of week rules, activated sensor rules, etc.) associated with processing the identified event may be accessed and/or determined. For example, one or more user profiles may be utilized to identify rules and/or parameters for processing the identified event. The identified event may then be processed utilizing the various rules and/or parameters.

At block 325, a determination may be made as to whether the identified event is a suspect event or a potential alert event. For example, a determination may be made as to whether the identified event is an unexpected event. If it is determined at block 325 that the identified event is not a suspect event, then operations may continue at block 330. At block 330, the monitoring system may be automatically deactivated based at least in part upon the identification of the event. A wide variety of suitable deactivation events may be identified as desired in various embodiments of the invention. For example, a deactivation event may be identified in the event that a user device reestablishes communication with a monitoring system and/or based upon a determination that the user devices is located within the household. As another example, a deactivation event may be identified if a user reenters a home within a predetermined period of time after exiting the home. As yet another example, a deactivation event for an area (e.g., downstairs, etc.) of a household may be identified if activity is detected within another area (e.g., upstairs, etc.) of the household. Other suitable deactivation events will be readily apparent, and the events described above are provided by way of example only. Operations may end following block 330.

If, however, it is determined at block 325 that the identified event is a suspect event or an unexpected event, then operations may continue at block 335. At block 335, one or more rules for processing the identified suspect event may be identified and evaluated. In this regard, one or more suitable control actions may be executed. In certain embodiments, a local monitoring application may determine whether one or more rules that initiate a local action have been satisfied. For example, the local monitoring application may determine whether a local action rule indicates that an alarm should be triggered and/or whether an event should be recorded. Additionally, in certain embodiments, a local monitoring application may determine whether one or more rules that instruct the application to pass the information to a central monitoring application have been satisfied. For example, the local monitoring application may determine whether information associated with the suspect event should be communicated to the central server and/or whether an alarm should be escalated to the central server. In order to facilitate the processing of the identified event, a wide variety of user preferences and/or parameters may be evaluated. Additionally, as desired in certain embodiments, a determination may be made as to whether information associated with the identified event should be passed to a learning algorithm that runs in parallel with a monitoring application. In this regard, evaluation rules may be adapted and/or updated based upon the monitoring history.

In the event that monitoring information and/or an alert associated with an identified event is communicated to a central server, the central server may further process the data associated with the identified event. In doing so, the central server may take a wide variety of processing rules and/or parameters, including user-defined parameters, into consideration. Additionally, as desired, the central server may pass information associated with the identified event to a suitable learning algorithm.

Any number of control actions may be triggered based upon the analysis of the one or more rules by the local monitoring system and/or the central server. An example of a control action may include the communication of a notification to the user(s), such as an email notification, short message service notification, and/or telephone call. Alternatively, in certain embodiments, no action may be triggered. For example, an audible alarm may be set off and/or authorities may be contacted. Additionally, the operation of one or more sensors may be modified. As an example, if three consecutive sensor state changes have occurred within the last 30 minutes, the system may ignore input from that sensor until 15 minutes has passed with no activity on any sensor. As another example, if the system determines that someone has entered the home, further activity may be ignored until the system determines that someone has left the home. As another example, if the system determines that someone has entered the home, then activity associated with the person may be recorded and/or stored. As yet another example, if somebody exits the home and reenters to the home within 15 minutes, the application may not trigger an action and may maintain the state level before the exit was sensed.

At block 340, a determination may be made as to whether input from the user has been received in association with the identified event. For example, a determination may be made as to whether user input associated with an alarm has been received. If it is determined at block 340 that no user input has been received, then operations may end. If, however, it is determined at block 340 that user input has been received, then operations may continue at block 345, and the received user input may be processed. A wide variety of different types of user input may be received and processed as desired in various embodiments of the invention. For example, user input could instruct the system in 100 to activate a sensor (120, 125, 130) or an output from a sensor, deactivate the system, update the user preferences, etc. As another example, the user input may instruct the monitoring system to escalate an alarm or an alert. As desired, the user input may also be used to modify the rules or the input may be submitted to the learning algorithm.

The method 200 may end following block 240.

The operations described in the methods 200, 300 of FIGS. 2 and 3 do not necessarily have to be performed in the order set forth in FIGS. 2 and 3, but instead may be performed in any suitable order. Additionally, in certain embodiments of the invention, more or less than all of the elements or operations set forth in FIGS. 2 and 3 may be performed.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
identifying, by a system comprising one or more computers, one or more parameters associated with the automatic activation of a monitoring system, wherein the one or more parameters are identified by a learning algorithm based upon historical information associated with the monitoring system;
determining, by the system, whether the one or more parameters have been satisfied; and
automatically activating, by the system if it is determined that the one or more parameters have been satisfied, the monitoring system.

2. The method of claim 1, further comprising:
receiving, by the system, one or more user preferences associated with the automatic activation of the monitoring system; and
provide, by the system, the one or more user preferences to the learning algorithm.

3. The method of claim 1, wherein identifying one or more parameters comprises identifying one or more parameters associated with a user device in communication with the monitoring system, and
wherein determining whether the one or more parameters have been satisfied comprises determining whether the user device ceases communication with the monitoring system.

4. The method of claim 3, wherein identifying one or more parameters associated with a user device comprises identifying one or more parameters associated with a mobile device.

5. The method of claim 1, wherein identifying one or more parameters comprises identifying a time period for detecting no activity, and
wherein determining whether the one or more parameters have been satisfied comprises determining that no activity is detected for the time period.

6. The method of claim 1, wherein identifying one or more parameters comprises:
identifying at least one of (i) a time of day or (ii) a day of week; and
determining one or more automatic activation parameters based at least in part upon the time of day or day of week.

7. The method of claim 1, wherein the monitoring system is automatically activated, and further comprising:
identifying, by the system based at least in part upon data collected by the monitoring system, a monitoring event; and
processing, by the system, the identified monitoring event.

8. The method of claim 7, wherein processing the identified monitoring event comprises:
determining that the identified monitoring event is a suspicious event; and
implementing one or more control actions based upon the determination that the identified monitoring event is a suspicious event.

9. The method of claim 7, wherein processing the identified monitoring event comprises:
determining that the identified monitoring event comprises a deactivation event; and
automatically deactivating the monitoring system based upon the determination that the identified event comprises a deactivation event.

10. The method of claim 9, wherein determining that the identified event comprises a deactivation event comprises:
identifying one or more deactivation parameters associated with the automatic deactivation of a monitoring system; and
determining that the one or more deactivation parameters have been satisfied.

11. A system comprising:
at least one memory operable to store computer-executable instructions;
at least one processor configured to access the at least one memory and execute the computer-executable instructions to:
identify one or more parameters associated with the automatic activation of a monitoring system, wherein the one or more parameters are identified by a learning algorithm based upon historical information associated with the monitoring system;
determine that the one or more parameters have been satisfied; and
automatically activate the monitoring system based upon the determination that the one or more parameters have been satisfied.

12. The system of claim 11, wherein the at least one processor is further configured to execute the computer-executable instructions to:
receive one or more user preferences associated with the automatic activation of the monitoring system; and
provide the one or more user preferences to the learning algorithm.

13. The system of claim 11, wherein:
the one or more parameters comprise one or more parameters associated with a user device in communication with the monitoring system, and
the at least one processor is configured to determine that the one or more parameters have been satisfied based upon a determination that the user device ceases communication with the monitoring system.

14. The system of claim 13, wherein the user device comprises a mobile device.

15. The system of claim 11, wherein:
the one or more parameters comprises a time period for detecting no activity, and
the at least one processor is configured to determine that the one or more parameters have been satisfied based upon a determination that no activity is detected for the time period.

16. The system of claim 11, wherein the at least one processor is further configured to execute the computer-executable instructions to:
determine at least one of (i) a time of day or (ii) a day of week, and
identify the one or more parameters based at least in part upon the time of day or day of week.

17. The system of claim 11, wherein the monitoring system is automatically activated, and wherein the at least one processor is further configured to execute the computer-executable instructions to:
identify, based at least in part upon data collected by the monitoring system, a monitoring event; and
process the identified monitoring event.

18. The system of claim 17, wherein the at least one processor is configured to process the identified monitoring event by executing the computer-executable instructions to:
determine that the identified monitoring event is a suspicious event; and
direct implementation of one or more control actions based upon the determination that the identified monitoring event is a suspicious event.

19. The system of claim 17, wherein the at least one processor is configured to process the identified monitoring event by executing the computer-executable instructions to:
determine that the identified monitoring event comprises a deactivation event; and
automatically deactivate the monitoring system based upon the determination that the identified event comprises a deactivation event.

20. The system of claim 19, wherein the at least one processor is configured to determine that the identified event comprises a deactivation event by executing the computer-executable instructions to:
identify one or more deactivation parameters associated with the automatic deactivation of a monitoring system; and
determine that the one or more deactivation parameters have been satisfied.
